(19) United States
(12) Patent Application Publication
(10) Pub. No.: US 2025/0039322 A1
(43) Pub. Date: Jan. 30, 2025

(54) IMAGE PROCESSING APPARATUS AND CONTROL METHOD

(71) Applicant: CANON KABUSHIKI KAISHA, Tokyo (JP)

(72) Inventor: ARAN KUNIMATSU, Kanagawa (JP)

(21) Appl. No.: 18/781,250

(22) Filed: Jul. 23, 2024

(30) Foreign Application Priority Data
Jul. 24, 2023 (JP) 2023-119684

(51) Int. Cl. H04N 1/44; H04N 1/00

(52) U.S. Cl. CPC H04N 1/4433; H04N 1/00477; H04N 2201/0094

(57) ABSTRACT

An image processing apparatus includes one or more memories storing instructions and one or more processors capable of executing the instructions. Execution of the instructions causes the one or more processors to cause the image processing apparatus to enable restriction on some functions of the image processing apparatus as a first function restriction, enable restriction on some functions of the image processing apparatus as a second function restriction different from the first function restriction, and perform control on a function targeted for restriction by both the first function restriction and the second function restriction, in accordance with a setting value of the function based on the restrictions.

### BACKGROUND

### Field of the Disclosure

The present disclosure relates to a technique for controlling the restriction of functions provided by an image processing apparatus.

### Description of the Related Art

Personal computers (PCs) and server equipment (such as a file server and an authentication server) connected to office networks are desirably operated in compliance with security policies determined on an office basis. Security policies are fundamental guidelines regarding a company's overall information security that is a set of guidelines to regulate the use of information and prevent intrusion from external sources and information leakage.

Aside from PCs and server equipment, examples of devices connected to office networks include image processing apparatuses, such as a multifunction peripheral and a printer. Recent image processing apparatuses do not only simply print or transmit images but can provide users with a web user interface (UI) with which the image processing apparatuses can be operated from a web browser on a PC. Image processing apparatuses can also provide various cloud services in collaboration with cloud servers. In other words, image processing apparatuses are coming to play a role similar to that of other PCs and server equipment on the network. To maintain a safe and secure office environment, it is therefore desirable that image processing apparatuses also comply with the security policies like PCs and server equipment. As employed herein, complying with security policies means imposing security operation constraints on the image processing apparatuses to prevent unauthorized use and information leakage. Examples include mandating user authentication when operating the image processing apparatuses, and mandating encryption of communication paths.

Such image processing apparatuses exercise control to maintain a state compliant with the security policies. Specifically, with a technique discussed in Japanese Patent Application Laid-Open No. 2017-163557, when a security policy is set, specific setting items related to the security policy become fixed values so that the setting items are unable to be changed by users other than the security administrator.

As employed herein, a security policy function refers to a feature that allows users with a security administrator attribute (role or privilege) in the user environment or organization owning the image processing apparatus to set a desired security policy, whereby changes to specific security-related setting values are restricted.

As employed herein, the attributes of users of an image processing apparatus may include an administrator attribute and a guest user attribute aside from the security administrator attribute. There is also a service attribute prepared for sales companies (dealers) of image processing apparatuses and servicepersons in charge of installation and maintenance to customize the image processing apparatus for specific use purposes.

With a diversification in the functions of image processing apparatuses, there are increasing cases where servicepersons with the service attribute install the image processing apparatuses while restricting use of some functions or changes in setting values for specific use purposes, such as business negotiations. As employed herein, settings that restrict some functions or setting changes of an image processing apparatus for specific use purposes are referred to as operation restriction settings.

As described above, a plurality of techniques for restricting the functions of an image processing apparatus are being incorporated, such as security policy settings and operation restriction settings. This may result in overlapping of operations and setting values targeted for restriction by the respective restriction functions, which leads to a growing demand for control of appropriate function restrictions.

### SUMMARY

According to an aspect of the present disclosure, an image processing apparatus includes one or more memories storing instructions, and one or more processors capable of executing the instructions. Execution of the instructions causes the one or more processors to cause the image processing apparatus to enable restriction on some functions of the image processing apparatus as a first function restriction, enable restriction on some functions of the image processing apparatus as a second function restriction different from the first function restriction, and perform control on a function targeted for restriction by both the first function restriction and the second function restriction, in accordance with a setting value of the function based on the restrictions.

Further features of various embodiments will become apparent from the following description of exemplary embodiments with reference to the attached drawings.

### BRIEF DESCRIPTION OF THE DRAWINGS

FIG. 1 is a diagram illustrating a network configuration.

FIG. 2 is a diagram illustrating appearance of an image processing apparatus.

FIG. 3 is a block diagram illustrating a configuration of the image processing apparatus.

FIG. 4 is a diagram illustrating an operation display unit of the image processing apparatus.

FIG. 5 is a block diagram schematically illustrating a software configuration of the image processing apparatus.

FIGS. 6A and 6B are diagrams schematically illustrating setting item management information about the image processing apparatus.

FIGS. 7A to 7C are diagrams schematically illustrating restriction tables of various function restriction settings of the image processing apparatus.

FIGS. 8A to 8D are diagrams illustrating examples of screens that are displayed by a web browser of a terminal apparatus when security policy settings are set.

FIG. 9 is a flowchart illustrating security policy setting processing.

FIG. 10 illustrates an example of an application screen that displays a maintenance tool running on the terminal apparatus when operation restriction settings are set.

FIG. 11 illustrates examples of setting screens that are displayed when guest user restrictions on the image processing apparatus are set.

FIG. 12 illustrates examples of a login screen that is displayed when a guest user setting is enabled.

FIGS. 13A and 13B are diagrams illustrating examples of output in execution of a device information print function.

FIG. 14 is a diagram illustrating examples of a setting screen that is displayed when a setting reset function of the image processing apparatus is executed.

FIG. 15 is a diagram illustrating examples of a setting screen that is displayed when wireless local area network (LAN) connection setting of the image processing apparatus is executed.

FIG. 16 is a flowchart according to a first exemplary embodiment, where a setting management application of the image processing apparatus receives a restriction check request.

FIG. 17 is a diagram schematically illustrating priority information between restriction functions of an image processing apparatus according to a second exemplary embodiment.

FIG. 18 is a flowchart according to the second exemplary embodiment, where a setting management application of the image processing apparatus receives a restriction check request.

### DESCRIPTION OF THE EMBODIMENTS

Hereinafter, exemplary embodiments will be described with reference to the drawings. However, it should be understood that some embodiments include modifications and improvements to the exemplary embodiments described below based on the ordinary knowledge of those skilled in the art without departing from the spirit of the present disclosure.

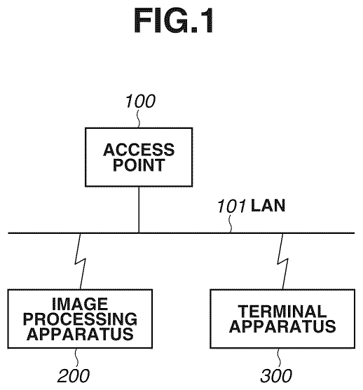

A network configuration according to a first exemplary embodiment will be described with reference to FIG. 1. The following network configuration is just an example embodiment, and is applicable to various configurations where an image processing apparatus and a terminal apparatus can communicate in a wired or wireless manner. The configuration is not limited exactly to what is illustrated in the diagram. In the following description and drawings, the term “network” may be abbreviated as NW.

FIG. 1 illustrates a local area network (LAN) 101 constructed by an access point 100, and an image processing apparatus 200 and a terminal apparatus 300 that are connected to the LAN 101. The LAN 101 may be connected by wired communication or wireless communication. For example, the LAN 101 is connected by Wireless Fidelity (Wi-Fi)®, a communication standard compliant to the Institute of Electrical and Electronics Engineers (IEEE) 802.11 series. On the LAN 101, the image processing apparatus 200 and the terminal apparatus 300 are assigned different Internet Protocol (IP) addresses by the access point 100. The apparatuses on the LAN 101 can thus communicate with each other by designating IP addresses as destination addresses. The image processing apparatus 200 is an inkjet printer, for example, and provides functions such as print, scan, and facsimile (FAX) functions to the user. The image processing apparatus 200 further has a web server function, and can receive requests and transmit responses using Hypertext Transfer Protocol (HTTP) communication. The functions incorporated in the image processing apparatus 200 do not need to be limited thereto. Some of the functions mentioned may not be incorporated, and functions other than those mentioned may be incorporated. The image processing apparatus 200 is not limited to an inkjet printer, and may be other apparatuses, such as a laser beam printer and an office multifunction peripheral. The terminal apparatus 300 is a tablet apparatus, for example, and can internally provide a web browser function and a maintenance tool for the image processing apparatus 200 to the user. The web browser function and the maintenance tool transmit requests and receive responses using HTTP communication, and provide screen display accompanying the communications. The functions of the terminal apparatus 300 do not need to be limited thereto, and functions other than those mentioned may be incorporated. The terminal apparatus 300 is not limited to a tablet terminal, and may be other apparatuses such as a personal computer (PC) and a smartphone.

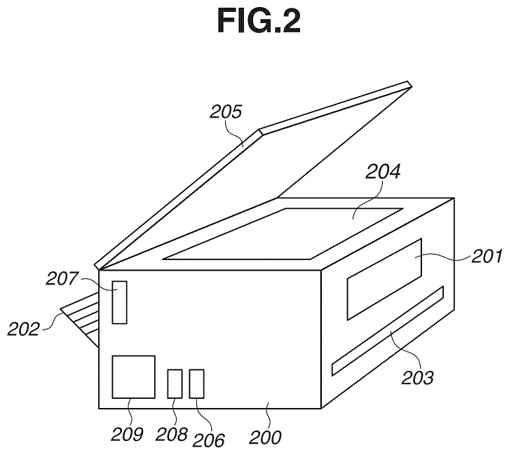

FIG. 2 is a diagram illustrating the appearance of the image processing apparatus 200. In the present exemplary embodiment, an inkjet printer is illustrated as the image processing apparatus 200. This inkjet printer is a multifunction printer (MFP) having the print, scan, and FAX functions and other functions.

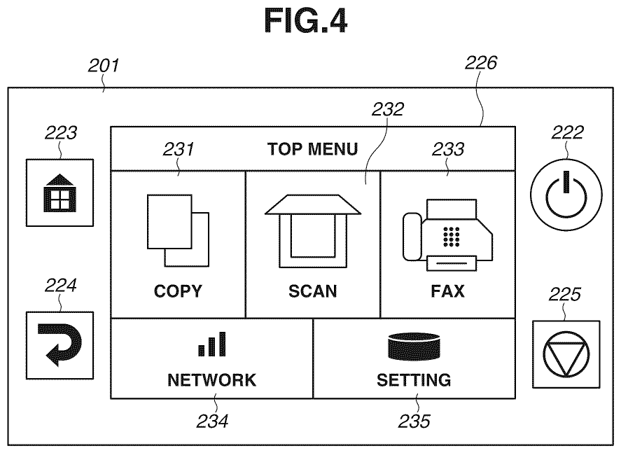

An operation display unit 201 includes a display and buttons that are used in operation of the image processing apparatus 200. Details will be described with reference to FIG. 4. A print sheet insertion port 202 is an insertion port where various sizes of sheets are set. The sheets set from the print sheet insertion port 202 are conveyed to a print unit one by one, given desired printing, and discharged from a print sheet discharge port 203. A document platen 204 is a glass-like transparent table and used in reading a placed document with a scanner (scan unit). A document platen pressing plate 205 is a cover that presses a document to be read by the scanner against the document platen 204 to prevent the document from lifting, and shields the scan unit from external light. A Universal Serial Bus (USB) communication unit 206 includes a circuit and a USB connector via which the image processing apparatus 200 communicates with the external terminal apparatus 300 through USB connection. A wireless LAN communication unit 207 includes embedded circuits, such as an antenna, for performing wireless communication through the foregoing wireless connection and direct connection where the image processing apparatus 200 itself serves as an access point to construct a wireless LAN. A FAX communication unit 208 includes a circuit for performing FAX transmission and reception, and a telephone line connector. A power supply unit 209 includes a power supply circuit and a power jack for supplying power to the image processing apparatus 200.

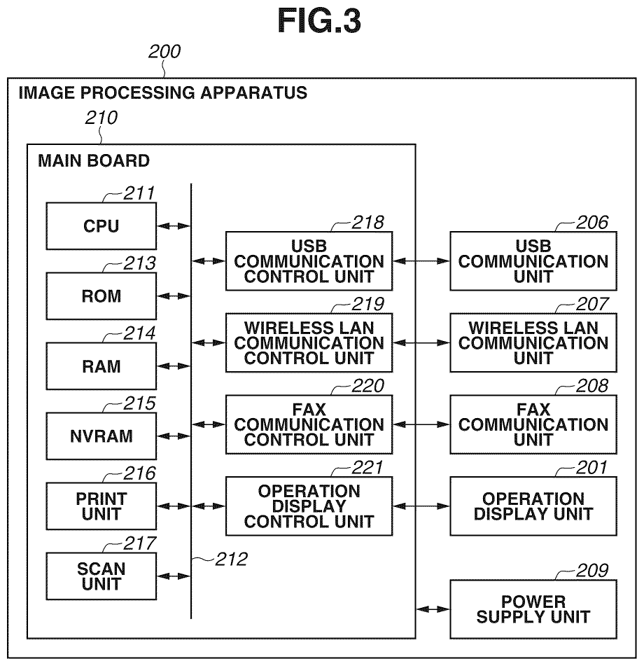

FIG. 3 is a block diagram illustrating a configuration of the image processing apparatus 200. The image processing apparatus 200 includes a main board 210 that controls entire operation of the image processing apparatus 200, and the operation display unit 201, the USB communication unit 206, the wireless LAN communication unit 207, the FAX communication unit 208, and the power supply unit 209.

A central processing unit (CPU) 211 that is in a microprocessor form and is mounted on the main board 210 operates based on a control program stored in a read-only memory (ROM) 213 and data stored in a random access memory (RAM) 214, both of which are connected via an internal bus 212. Various settings of the image processing apparatus 200 are stored in a nonvolatile RAM (NVRAM) 215 that is a nonvolatile memory, and read and written based on the control program. Processing described with reference to a flowchart to be described below according to the exemplary embodiment is also implemented by the CPU 211 executing control programs corresponding to respective processes.

The CPU 211 reads a document by controlling a scan unit 217, and stores the read image in an image memory that is a part of the RAM 214. The CPU 211 can print images stored in the image memory that is a part of the RAM 214 on a recording medium by controlling a print unit 216. The CPU 211 performs USB communication with an external apparatus through USB connection by controlling the USB communication unit 206 via a USB communication control unit 218. The CPU 211 performs wireless LAN communication with an external apparatus through infrastructure connection or direct connection by controlling the wireless LAN communication unit 207 via a wireless LAN communication control unit 219. The CPU 211 performs FAX communication with an external apparatus using a telephone line by controlling the FAX communication unit 208 via a FAX communication control unit 220. The CPU 211 accepts operation information from the operation display unit 201 by controlling an operation display control unit 221. The CPU 211 can also display the status of the image processing apparatus 200 and a function selection menu on the operation display unit 201 by controlling the operation display control unit 221.

FIG. 4 is a diagram schematically illustrating an example of a configuration of the operation display unit 201 of the image processing apparatus 200. The operation display unit 201 includes a plurality of buttons, a display, and a light-emitting diode (LED).

FIG. 4 illustrates a case where a liquid crystal touchscreen 226 is employed as the display of the operation display unit 201. The image processing apparatus 200 starts up when the user presses a power button 222 with the operation display unit 201 powered by the power supply unit 209.

When the image processing apparatus 200 starts up, the liquid crystal touchscreen 226 displays a home screen that is the top-level menu operable by the user. The home screen includes a copy area 231 to receive execution instructions for the copy function, a scan area 232 to receive execution instructions for the scan function, and a FAX area 233 to receive execution instructions for the FAX function.

The home screen also includes a network area 234 to transition to a menu on which network settings, such as infrastructure connection and direct connection, are changed and the status of the image processing apparatus 200 is checked. The home screen further includes a setting area 235 to transition to a menu on which various other settings are changed and a setting reset function are executed.

In a case where the user inputs a character string for password authentication, a software keyboard can be displayed on the liquid crystal touchscreen 226 to accept input.

In response to a home button 223 being pressed with a screen of a different menu level other than the home screen displayed, the screen can be restored to the home screen. In response to a return button 224 being pressed with a screen of a different menu level other than the home screen displayed, the screen can be moved back to the screen one level higher. In response to a cancel button 225 being pressed during execution of various functions, such as the copy function and the scan function, and if the process can be aborted, the ongoing process can be aborted.

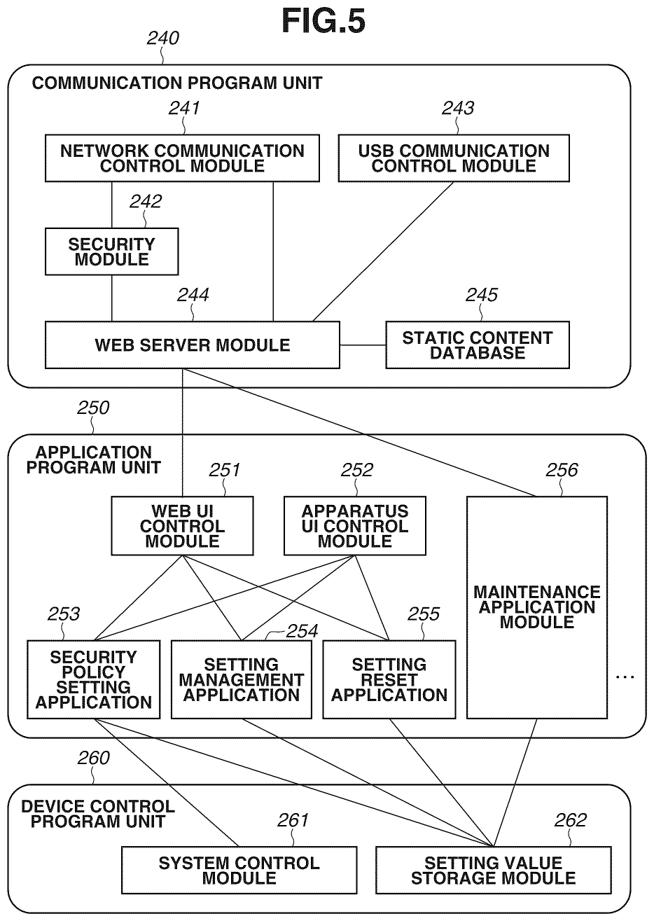

FIG. 5 is a block diagram conceptually illustrating a software configuration for implementing setting changes, the setting reset function, and function restrictions, among pieces of software running on the image processing apparatus 200. Processing that is executed for the setting reset function will be referred to as setting reset processing, or simply as reset processing.

The software elements and configuration illustrated in FIG. 5 are merely examples, and the elements and configuration are not limited exactly to those illustrated in the diagram. The software group schematically illustrated in FIG. 5 is a part of control programs stored in the ROM 213 and accompanying data stored in the RAM 214. The software group includes a communication program unit 240 that mainly performs communication control, an application program unit 250 that mainly controls application functions, and a device control program unit 260 that mainly performs lower-layer control of the image processing apparatus 200.

The communication program unit 240 includes a network communication control module 241, a security module 242, a USB communication control module 243, a web server module 244, and a static content database 245.

The network communication control module 241 is a module that controls the wireless LAN communication control unit 219 and takes charge of the communication protocol stack up to the transport layer. The network communication control module 241 implements Transmission Control Protocol/Internet Protocol (TCP/IP) communication of the image processing apparatus 200.

The security module 242 is a module that encrypts and decrypts communication and performs accompanying processing, such as authentication and hash processing. The security module 242 implements Transport Layer Security/Security Socket Layer (TLS/SSL) communication of the image processing apparatus 200. The USB communication control module 243 is a module that controls the USB communication control unit 218 and governs operations to behave as a USB device. The USB communication control module 243 implements USB communication of the image processing apparatus 200.

The web server module 244 is a module that governs operations for the image processing apparatus 200 to behave as a web server. The web server module 244 implements HTTP communication with the terminal apparatus (external terminal apparatus) 300 on which a web browser runs. Specifically, the web server module 244 analyzes HTTP requests received from the external terminal apparatus 300, and operates a web user interface (UI) control module 251, the static content database 245, and a maintenance application module 256 based on the analysis. The web server module 244 then formats data generated by the web UI control module 251, the static content database 245, and the maintenance application module 256 into HTTP responses and transmits the HTTP responses. The web server module 244 receives requests and transmits responses using TCP/IP communication, TLS/SSL communication, or USB communication. The static content database 245 is a module that operates as a file system, and reads Joint Photographic Experts Group (JPEG) data and Hypertext Markup Language (HTML) data stored in the ROM 213 or the RAM 214.

The application program unit 250 includes the web UI control module 251, an apparatus UI control module 252, application modules including a security policy setting application 253, a setting management application 254, and a setting reset application 255, and the maintenance application module 256.

The web UI control module 251 generates data to display a web UI of the image processing apparatus 200 on the web browser of the external terminal apparatus 300, based on requests from the web server module 244. The web UI control module 251 acquires the operation status and setting statuses of the image processing apparatus 200 from the application modules 253 to 255, formats the statuses into data, and returns the data, whereby the operating status and setting statuses of the image processing apparatus 200 are displayed on the web UI.

The web UI displayed on the web browser of the terminal apparatus 300 is also configured so that instructions for setting changes and password authentication of the image processing apparatus 200 can be issued. In a case where the user operates the web browser and issues instructions to perform setting changes or password authentication of the image processing apparatus 200 from the web UI, the image processing apparatus 200 receives HTTP requests including the instruction content.

The web UI control module 251 receives the instructions via the web server module 244 and causes the application module(s) corresponding to the instruction content to perform processing, such as setting changes and password authentication. After completion of the processing, the web UI control module 251 stores the processing result, such as a success or failure, in an HTTP response and transmits the HTTP response.

The apparatus UI control module 252 implements the main body UI of the image processing apparatus 200 by controlling the operation display control unit 221. The apparatus UI control module 252 stores menu hierarchy information, and displays an operation menu corresponding to the current menu level on the liquid crystal touchscreen 226. The apparatus UI control module 252 can also acquire the operation status and setting statuses of the image processing apparatus 200 from the application modules 253 to 255, formats the statuses, and displays the formatted information on the liquid crystal touchscreen 226. Further, the apparatus UI control module 252 receives operations for setting changes and password authentication from the operation display unit 201 and causes the corresponding application module(s) to perform processing based on the operations. After completion of the processing, the apparatus UI control module 252 displays the processing result, such as a success or failure, on the liquid crystal touchscreen 226.

The security policy setting application 253 receives instructions from the web UI control module 251 and the apparatus UI control module 252, acquires security policy setting statuses, and changes security policy settings.

The setting management application 254 receives instructions from the web UI control module 251 and the apparatus UI control module 252, acquires the setting statuses of the image processing apparatus 200, and changes the settings. The setting management application 254 receives restriction check instructions from the web UI control module 251 and the apparatus UI control module 252, acquires a function restriction status of the image processing apparatus 200, and performs determination of whether checking target functions are restricted.

The setting reset application 255 receives instructions from the web UI control module 251 and the apparatus UI control module 252 and performs full setting reset processing and security policy reset processing of the image processing apparatus 200.

The maintenance application module 256 is a software module that operates when the image processing apparatus 200 is in a maintenance mode. The maintenance mode is a special mode for production, repair, and service support of the image processing apparatus 200, and can be entered through special key entries.

The maintenance application module 256 performs processing based on instructions from the maintenance tool running on the external terminal apparatus 300 and generates response data, based on requests from the web server module 244. The maintenance tool can issue instructions to execute factory shipment reset processing and acquire and change the operation restriction setting statuses of the image processing apparatus 200. In the present exemplary embodiment, such instructions are implemented by HTTP requests. Receiving the instructions, the maintenance application module 256 acquires or changes setting values stored in the NVRAM 215 via a setting value storage module 262, and generates response data corresponding to the instructions. The generated response data is formatted into HTTP responses via the web server module 244 and returned to the terminal apparatus 300.

The device control program unit 260 includes a system control module 261 and the setting value storage module 262. The system control module 261 is in charge of operations to control the entire software system, such as starting and stopping the image processing apparatus 200.

In the present exemplary embodiment, the system control module 261 receives a restart request from the security policy setting application 253 and performs restart processing of the image processing apparatus 200. The setting value storage module 262 governs the storage of the setting values of the image processing apparatus 200. The setting value storage module 262 receives instructions to store setting values from other modules, such as the application modules 253 to 255, and writes the setting values to the NVRAM 215. The setting value storage module 262 receives instructions to refer to setting values from other modules, such as the application modules 253 to 255, and reads the setting values from the NVRAM 215.

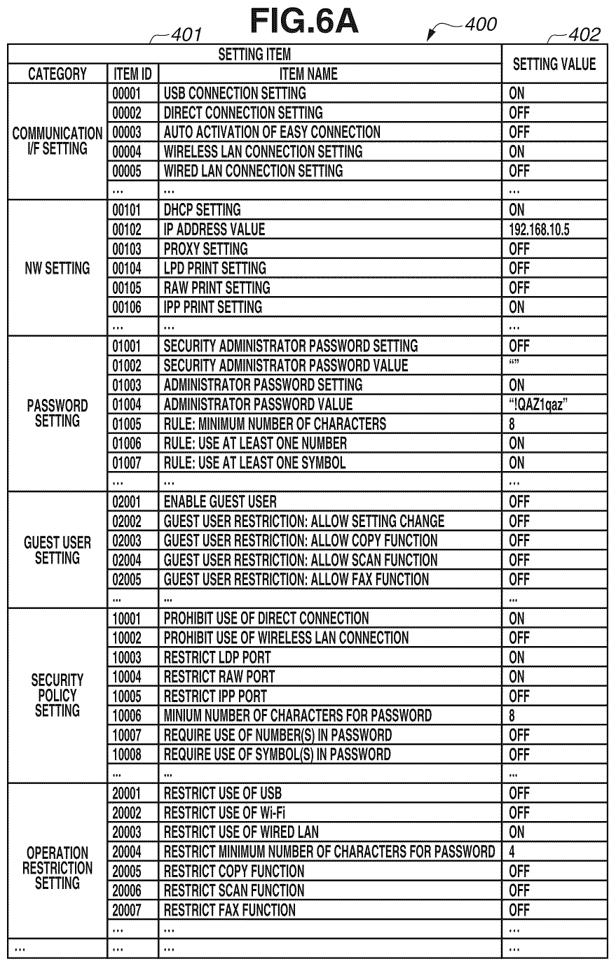

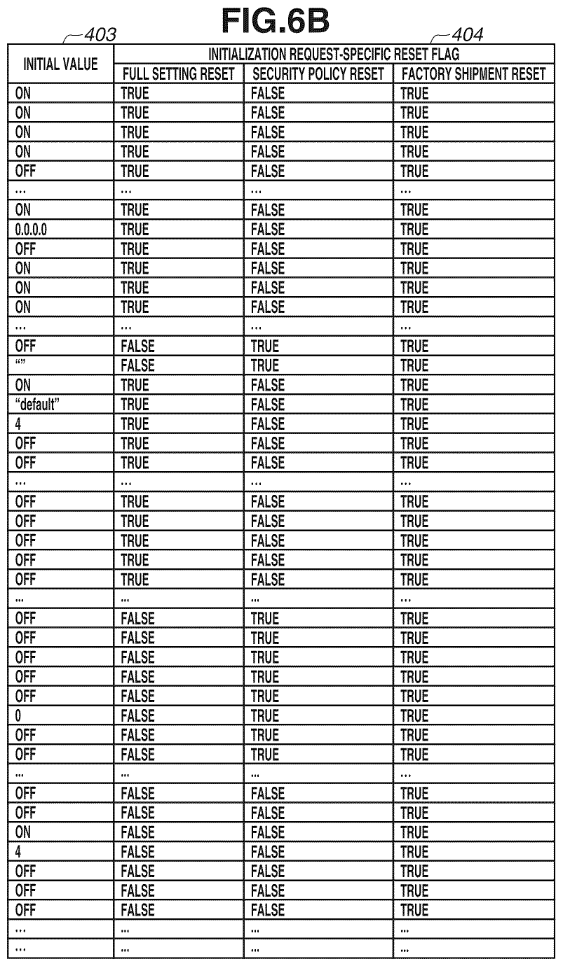

FIGS. 6A and 6B schematically illustrate a part of setting item management information 400 that is a combination of the setting values of setting items stored in the NVRAM 215 via the setting value storage module 262 and their management information. As illustrated in a column 401, all the setting items can be uniquely identified by item identifiers (IDs). The setting values can be written and read by specifying the item IDs. A column 402 lists the current setting values of the respective setting items. A column 403 lists the setting values of the respective setting items in a factory shipment state. Executing setting reset functions to be described below resets the target setting items of the setting reset functions to the factory shipment values listed in the column 403. A column 404 lists initialization request-specific reset flags indicating whether the setting items are subject to the setting reset functions when the respective setting reset functions are executed. TRUE indicates that the item is subject to the setting reset function. FALSE indicates that the item is not subject to the setting reset function.

Examples of the setting reset functions include full setting reset, security policy reset, and factory shipment reset.

The full setting reset resets the setting items of the image processing apparatus 200 that can be changed by the user, except for the security policy settings (restoration of setting values to their initial values is referred to as reset). Examples of setting items of the image processing apparatus 200 that are not changeable by the user may include operation restriction settings represented by item IDs of 20001 to 20007 in the column 401, and the serial number (not illustrated) of the image processing apparatus 200.

The security policy reset resets settings related to a security administrator password and the security policy settings. The security administrator password refers to a password that is managed by a user with the security administrator attribute (privilege) to protect the security policy settings from modification by third parties. In a case where the user sets a security administrator password value, the security administrator password setting turns on, in which case authentication using the password is performed in security policy setting operations and security policy reset operations.

The factory shipment reset forcibly resets all the resettable setting items of the image processing apparatus 200. The factory shipment reset is special processing for production, repair, and service support of the image processing apparatus 200, and can be executed by using the maintenance tool of the terminal apparatus 300.

While FIGS. 6A and 6B illustrate the setting item management information 400 in a table form, the format in which the image processing apparatus 200 stores the setting item management information 400 is not limited thereto. For example, the setting item management information 400 may be stored in a specific database format or in the form of a JavaScript Object Notation (JSON) file. Alternatively, only the setting values listed in the column 402 may be stored in the RAM 214 or the NVRAM 215 while the other information is expressed as a program stored in the ROM 213.

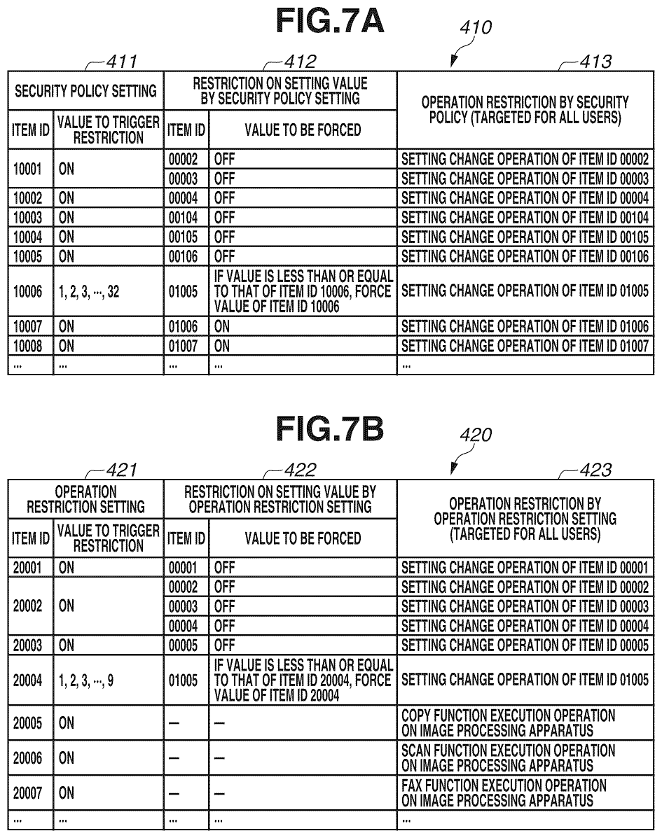

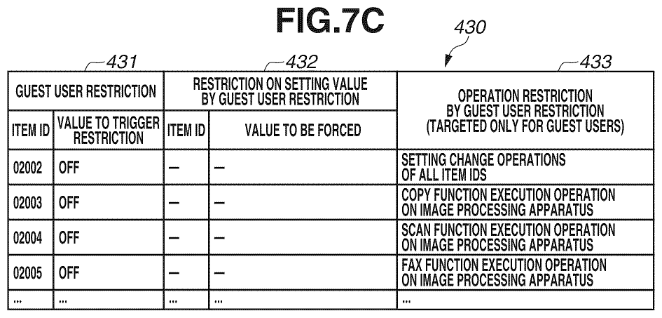

FIGS. 7A to 7C schematically illustrate, as restriction tables, the restriction operations due to the function restriction settings of the image processing apparatus 200. The image processing apparatus 200 according to the present exemplary embodiment has security policy settings, operation restriction settings, and guest user restrictions as the function restriction settings. The restriction tables illustrate how the function restriction settings restrict other setting values and operations.

In the present exemplary embodiment, in a case where guest users are allowed to access only some of the functions of the image processing apparatus 200, function restrictions can be set to prohibit operations such as setting changes on the image processing apparatus 200. Users with administrator attributes will be referred to as administrator users, and users without administrator attributes will be referred to as guest users. As employed herein, function restriction settings for guest users will be referred to as guest user restrictions.

FIG. 7A is a restriction table 410 of security policy settings. A column 411 lists the setting items of the security policy settings that serve as sources of restrictions, and setting values at which the restrictions are determined to be enabled. A column 412 lists setting items to be restricted when the restrictions are enabled, and setting values to which the items are restricted. A column 413 lists operations of the image processing apparatus 200 to be restricted when the restrictions are enabled. These operation restrictions are targeted for the users of all attributes. For example, in a case where the setting value of item ID 10001 in the security policy settings is set to “ON”, the setting value of item ID 00002 is forcibly set to “OFF” and the setting value of item ID 00003 is forcibly set to “OFF”. The setting change operations of item IDs 00002 and 00003 are also prohibited.

FIG. 7B is a restriction table 420 of operation restriction settings. The operation restriction settings are setting functions for imposing special function restrictions to be used for special purposes, using a dedicated tool called maintenance tool to be described below.

A column 421 lists the setting items of the operation restriction settings that serve as sources of restrictions, and setting values at which the restrictions are determined to be enabled. A column 422 lists setting items to be restricted when the restrictions are enabled, and setting values to which the items are restricted. In the column 422, “-” indicates that there is no setting item to be restricted when the restriction is enabled. A column 423 lists operations of the image processing apparatus 200 to be restricted when the restrictions are enabled. These operation restrictions are targeted for the users of all attributes. For example, in a case where the setting value of item ID 20001 in the operation restriction settings is set to “ON”, the setting value of item ID 00001 is forcibly set to “OFF” and the setting change operation of item ID 00001 is prohibited.

FIG. 7C is a restriction table 430 of guest user restrictions. A column 431 lists the setting items of the guest user restrictions that serve as sources of restrictions, and setting values at which the restrictions are determined to be enabled. A column 432 lists setting items to be restricted when the restrictions are enabled, and setting values to which the items are restricted. In the column 432, “-” indicates that there is no setting item to be restricted when the restriction is enabled. A column 433 lists operations of the image processing apparatus 200 to be restricted when the restrictions are enabled. These operation restrictions are targeted for guest users. For example, in a case where the setting value of item ID 02002 in the guest user restrictions is set to “ON”, all setting change operations of the image processing apparatus 200 by guest users are prohibited.

In a case where a plurality of function restriction settings imposes different restrictions on the same setting item or setting value of the image processing apparatus 200, the restrictions are controlled so that the stronger restriction is imposed. For example, in a case of settings in terms of the row where the restriction source has an item ID of 10006 in FIG. 7A and the row where the restriction source has an item ID of 20004 in FIG. 7B, both restrict the setting value of item ID 01005. In this case, in a case where the value of item ID 10006 is set at “10” and the value of item ID 20004 is set at “5”, the value of item ID 01005 is forcibly set to 10.

In other words, in a case where an additional function restriction setting is enabled and a different setting value is forcibly set, determination of whether the current setting value of the setting item to be restricted satisfies the restriction to be imposed is performed. Only in a case where the current setting value does not satisfy the restriction to be imposed, forcible change in the setting value is additionally performed. With this control, in a case where a function targeted for restriction by a plurality of restriction settings is used, use of the function of the image processing apparatus 200 can be controlled in such a manner that a setting value satisfying all the restrictions is used. In a case where use of the function itself is restricted by any of the restrictions, the function is completely restricted and becomes unusable at all.

In FIGS. 7A to 7C, the security policy settings, the operation restriction settings, and the guest user restrictions are illustrated in a table form with the setting values and operation restrictions of the three categories of function restriction settings. However, the format in which the image processing apparatus 200 stores such information is not limited to a table form. For example, the information may be stored in a specific database format, stored in a JSON file format, or expressed as a program stored in the ROM 213.

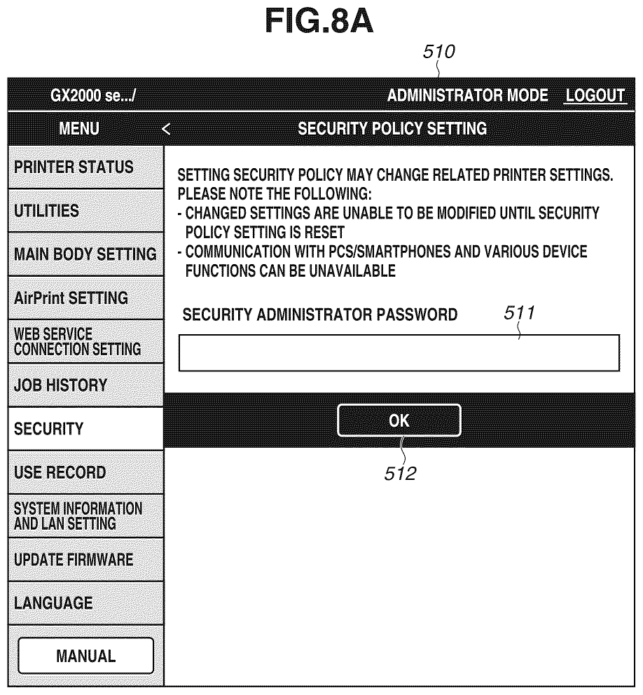

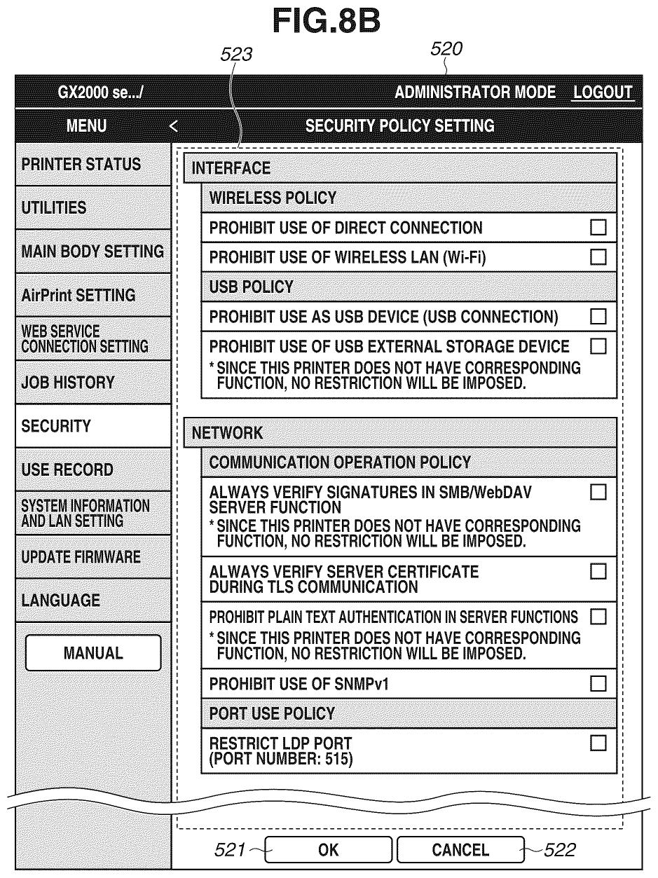

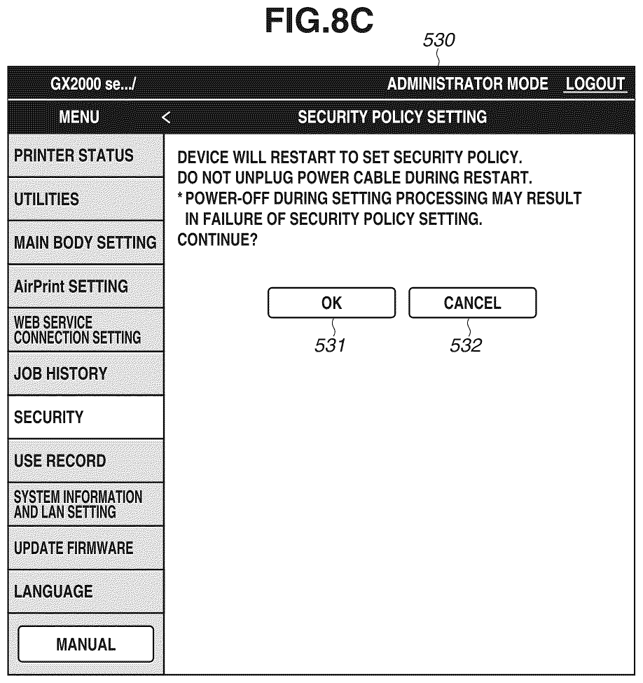

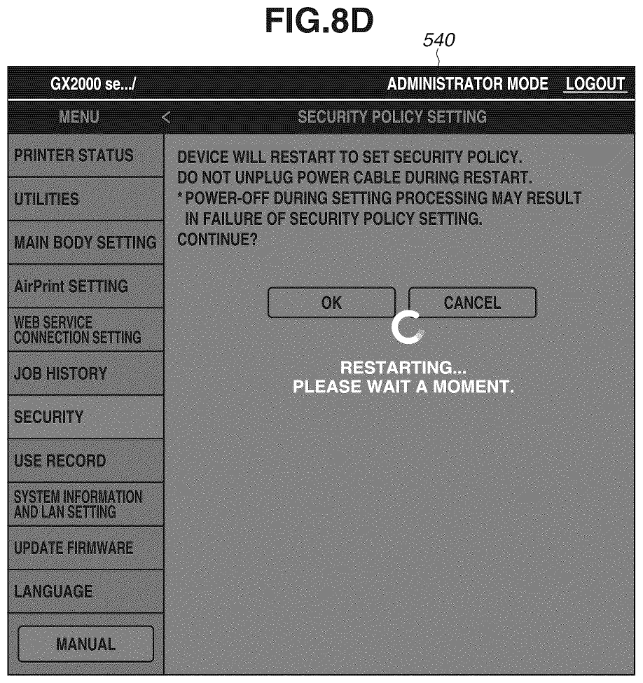

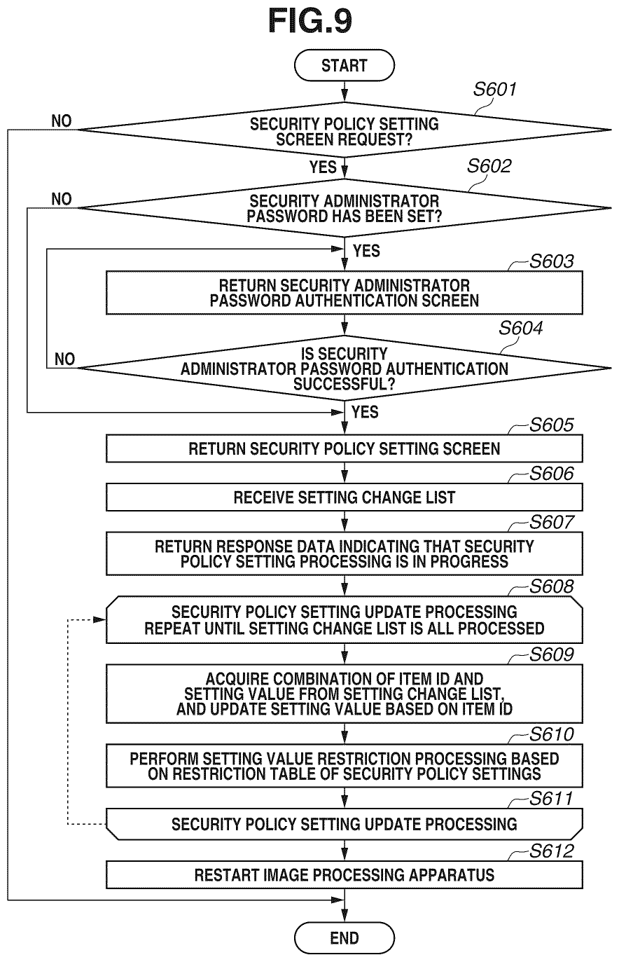

Next, processing in setting the security policy settings from the web UI will be described with reference to FIGS. 8A to 8D and FIG. 9. FIGS. 8A to 8D illustrate examples of screens displayed by the web browser of the terminal apparatus 300 in setting the security policy settings according to the present exemplary embodiment. FIG. 9 is a flowchart of the security policy setting processing by the image processing apparatus 200 according to the present exemplary embodiment. The steps illustrated in FIG. 9 are processed by the CPU 211 executing a program stored in the ROM 213.

The flowchart of FIG. 9 starts in response to the web server module 244 of the image processing apparatus 200 receiving an HTTP request from the web browser of the terminal apparatus 300.

In step S601, the web server module 244 performs determination of whether the received HTTP request is a security policy setting screen request. The determination of whether the received HTTP request is a security policy setting screen request is performed based on the requested uniform resource locator (URL) or request parameters. In a case where the HTTP request is not a security policy setting screen request (NO in step S601), the processing ends. Here, while the image processing apparatus 200 can also accept requests other than a security policy setting screen request, and thus continues to check for and process other acceptable requests, such operations deviate from the gist of this description and will thus be omitted. If the HTTP request is determined to be a security policy setting screen request (YES in step S601), the web server module 244 requests the web UI control module 251 to generate a security policy setting screen and the processing proceeds to step S602.

In step S602, the web UI control module 251 determines whether a security administrator password has been set. Specifically, the web UI control module 251 acquires the setting value of the security administrator password setting from the NVRAM 215 via the security policy setting application 253 and the setting value storage module 262. In a case where the acquired setting value indicates “ON”, the web UI control module 251 determines that a security administrator password has been set (YES in step S602), and the processing proceeds to step S603. In a case where the acquired setting value does not indicate ON, the web UI control module 251 determines that a security administrator password has not been set (NO in step S602), and the processing proceeds to step S605. In step S603, the web UI control module 251 generates a security administrator password authentication screen and returns the security administrator password authentication screen to the terminal apparatus 300 via the web server module 244.

FIG. 8A illustrates an example of a screen 510 that is displayed by the web browser of the terminal apparatus 300 receiving the security administrator password authentication screen returned from the image processing apparatus 200. The screen 510 includes an input field 511 to receive a security administrator password and an OK button 512 to perform authentication using the security administrator password. In response to the user inputting a security administrator password into the input field 511 and clicking the OK button 512, information about the input security administrator password is transmitted to the image processing apparatus 200.

Return to the flowchart of FIG. 9. In step S604, the image processing apparatus 200 performs determination of whether the security administrator password authentication using the received security administrator password is successful. Specifically, the image processing apparatus 200 receives the information about the security administrator password transmitted from the terminal apparatus 300, compares the information with the security administrator password value stored in the NVRAM 215, and determines whether the information and the security administrator password value match. In a case where the information and the security administrator password value do not match, the image processing apparatus 200 determines that the security administrator password authentication is failed (NO in step S604), and the processing returns to step S603. In step S603, the web UI control module 251 returns the security administrator password authentication screen to the web browser of the terminal apparatus 300 again to prompt re-entry of the password. In a case where the information about the security administrator password and the security administrator password value stored in the NVRAM 215 match, the image processing apparatus 200 determines that the security administrator password authentication is successful (YES in step S604), and the processing proceeds to step S605. In step S605, the web UI control module 251 generates a security policy setting screen, and returns the security policy setting screen to the terminal apparatus 300 via the web server module 244.

FIG. 8B illustrates an example of a screen 520 displayed by the web browser of the terminal apparatus 300 receiving the security policy setting screen returned from the image processing apparatus 200. An OK button 521 is a button for a confirmation of changes in the security policy settings. In response to the user pressing the OK button 521, a list of setting changes to the security policy settings operated on the screen 520 (hereinafter, referred to as a setting change list) is temporarily stored in the web browser, and the screen transitions to the screen illustrated in FIG. 8C. A cancel button 522 is a button for a cancellation of the security policy setting. In response to the user pressing the cancel button 522, the web browser transmits an HTTP request to request a menu screen one level higher than the security policy setting menu. The image processing apparatus 200 generates and returns data on the requested screen, and the flowchart illustrated in FIG. 9 ends (not illustrated). An area 523 displays various setting items related to security policies, along with checkboxes and textboxes for enabling the settings. The user operating the web browser on the terminal apparatus 300 can operate the foregoing checkboxes and textboxes to change the security policy settings of the image processing apparatus 200. FIG. 8C illustrates an example of a security policy setting execution confirmation screen 530. An OK button 531 is a button for transmission of the setting change list. In response to the user pressing the OK button 531, an HTTP request including the setting change list temporarily stored in the web browser is transmitted to the image processing apparatus 200. The setting change list here is information in a list form in which the values of item IDs and the changed setting values of the items included in the category “SECURITY POLICY SETTING” in the column 401 of FIG. 6A are combined. A cancel button 532 is a button for a cancellation of the transmission of the setting change list. In response to the user pressing the cancel button 532, the web browser displays the screen 520 again. Here, the web browser reads the temporarily stored setting change list and displays the screen 520 with the setting change list applied to the checkboxes and textboxes in the area 523.

Return to the flowchart of FIG. 9. In step S606, the image processing apparatus 200 receives the HTTP request including the setting change list transmitted by the terminal apparatus 300 and starts processing for changing the security policy settings. Specifically, the web UI control module 251 receives the setting change list via the web server module 244 and generates response data indicating that the security policy setting processing is in progress. In step S607, the web UI control module 251 returns an HTTP response including the response data indicating that the security policy setting processing is in progress to the terminal apparatus 300 via the web server module 244. The web UI control module 251 further passes the received setting change list to the security policy setting application 253. The processing proceeds to step S608.

FIG. 8D illustrates an example of a screen 540 displayed by the web browser of the terminal apparatus 300 receiving the response data indicating that the security policy setting processing is in progress, returned from the image processing apparatus 200. The screen 540 operates to not accept user operations. The web browser then regularly inquires by background processing about whether the security policy setting processing has been completed. After completion of the security policy setting processing, the web browser displays the web UI top screen (not illustrated) of the image processing apparatus 200.

Return to the flowchart of FIG. 9. The image processing apparatus 200 then performs loop processing illustrated in steps S608 to S611. This loop processing is repeated until the received setting change list is all processed. In the loop processing, step S609 is initially performed.

In step S609, the security policy setting application 253 acquires a combination of an item ID and a setting value that is yet to be processed by the loop processing from the setting change list. The security policy setting application 253 then stores the setting change of the acquired combination in the NVRAM 215 via the setting value storage module 262. Since the setting value is stored based on the item ID, the specified item of the security policy settings can be updated. In step S610, the security policy setting application 253 performs setting value restriction processing based on the restriction table 410 of the security policy settings illustrated in FIG. 7A. Specifically, the security policy setting application 253 extracts a row matching the item ID of the currently stored security policy setting in the column 411, and performs determination of whether the stored setting value matches the value to trigger restriction. In a case where the values match, the setting value is restricted based on the security policy as described in the column 412. For example, in a case where the acquired combination includes a setting change “item ID 10001, ON”, the security policy setting application 253 stores “OFF” as the setting value of item ID 00002, and “OFF” as the setting value of item ID 00003, into the NVRAM 215 via the setting value storage module 262. For example, in a case where the acquire combination includes a setting change “item ID 10006, 10”, the security policy setting application 253 acquires the current setting value of item ID 01005. In a case where the value is less than or equal to 10, the security policy setting application 253 stores 10 as the setting value of item ID 01005 into the NVRAM 215 via the setting value storage module 262. In step S611, in a case where there is still an unprocessed combination in the setting change list, the processing returns to step S608. In a case where there is no more unprocessed combination in the setting change list, the processing proceeds to step S612.

In step S612, the security policy setting application 253 transmits a request for a restart of the image processing apparatus 200 to the system control module 261. The system control module 261 received the request performs restart processing, and the flowchart ends.

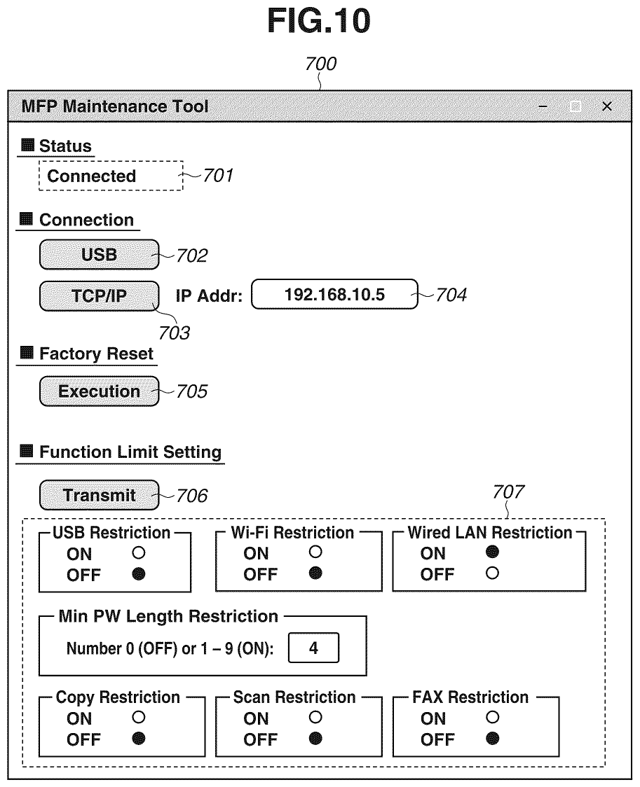

Next, a case of setting operation restriction settings of the image processing apparatus 200 from the maintenance tool running on the terminal apparatus 300 will be described with reference to FIG. 10. FIG. 10 illustrates an example of an application screen representing the maintenance tool for the image processing apparatus 200, running on the terminal apparatus 300. The maintenance tool connects to image processing apparatus 200 by USB connection or TCP/IP connection, and operates as an HTTP client to communicate with the maintenance application module 256.

A rectangular area 700 is an area that represents the entire graphical user interface (GUI) of the maintenance tool and is displayed when the maintenance tool is activated. Buttons for performing various functions of the maintenance tool are disposed in the rectangular area 700.

A status display area 701 is an area where the connection status between the maintenance tool and the image processing apparatus 200 is displayed. The status display area 701 displays “Connected” when the maintenance tool and the image processing apparatus 200 can communicate, and displays “Disconnected” when not. A USB connection button 702 is a button for establishment of a USB connection between the maintenance tool and the image processing apparatus 200. In response to the USB connection button 702 being pressed with the terminal apparatus 300 and the image processing apparatus 200 connected by a USB cable, the maintenance tool and the maintenance application module 256 enter a communicable state.

A TCP/IP connection button 703 is a button for establishment of a TCP/IP connection between the maintenance tool and the image processing apparatus 200. An IP address input field 704 is a textbox for inputting of the IP address of the connection destination. In response to the TCP/IP connection button 703 being pressed with the terminal apparatus 300 and the image processing apparatus 200 participating in the same network and the IP address of the image processing apparatus 200 being input to the IP address input field 704, the maintenance tool and the maintenance application module 256 enter a communicable state.

A factory shipment reset button 705 is a button for an instruction of the image processing apparatus 200 to execute the factory shipment reset processing. In response to the factory shipment reset button 705 being pressed with “Connected” displayed in the status display area 701, an HTTP request indicating the instruction to execute the factory shipment reset processing is transmitted to the image processing apparatus 200. In response to receipt of the HTTP request indicating the instruction to execute the factory shipment reset processing, the web server module 244 transmits a request for the factory shipment reset processing to the maintenance application module 256. In response to receipt of the request for the factory shipment reset processing, the maintenance application module 256 resets various setting values stored in the NVRAM 215 based on the factory shipment reset information illustrated in the column 404 of FIG. 6B. The maintenance application module 256 then generates response data indicating the completion of the factory shipment reset processing, and transmits the response data as an HTTP response to the maintenance tool via the web server module 244.

An operation restriction setting transmission button 706 is a button for an application of operation restriction settings specified in an operation restriction setting area 707 to the image processing apparatus 200. The operation restriction setting area 707 includes a plurality of radio buttons and a textbox and is configured so that operation restriction settings to be applied to the image processing apparatus 200 can be specified. In response to the operation restriction setting transmission button 706 being pressed with “Connected” displayed in the status display area 701, an HTTP request including the operation restriction settings specified in the operation restriction setting area 707 is transmitted to the image processing apparatus 200. In response to receipt of the HTTP request including the operation restriction settings, the web server module 244 transmits a request for operation restriction settings to the maintenance application module 256. In response to receipt of the request for the operation restriction setting, the maintenance application module 256 stores the requested operation restriction settings in the NVRAM 215. The maintenance application module 256 also changes various setting values stored in the NVRAM 215, based on the restriction table 420 of the operation restriction settings. The maintenance application module 256 then generates response data indicating the completion of the operation restriction setting, and transmits the response data as an HTTP response to the maintenance tool via the web server module 244.

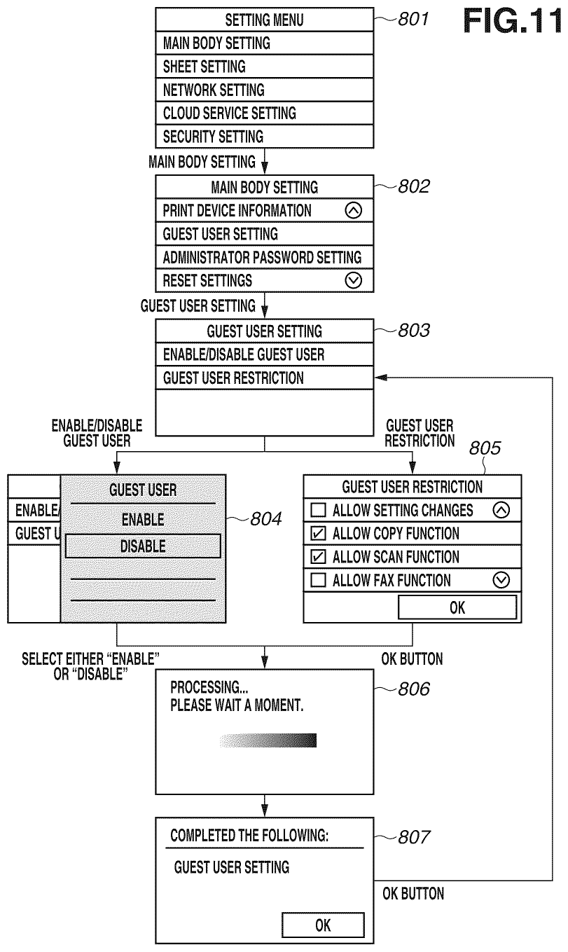

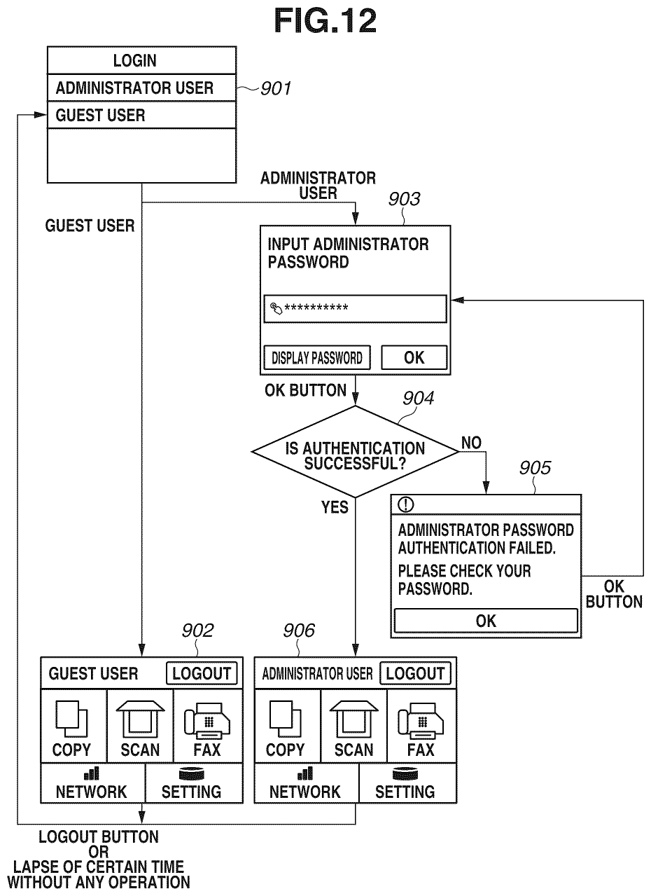

Next, the setting of guest user restrictions on the image processing apparatus 200 will be described with reference to FIGS. 11 and 12. The screen flows illustrated in FIGS. 11 and 12 are processed by the CPU 211 executing a program stored in the ROM 213. The apparatus UI control module 252 is mainly in charge of the control.

FIG. 11 illustrates examples of setting screens when the administrator user of the image processing apparatus 200 operates the operation display unit 201 to set guest user restrictions. In a case where the setting value of item ID 02001 “ENABLE GUEST USER” is “OFF”, operations using the operation display unit 201 of the image processing apparatus 200 are regarded as those of an administrator user (a state where the user is logged in as an administrator user). In a case where the setting value of item ID 02001 is “ON”, the user performs a login operation as an administrator user or a guest user when operating the operation display unit 201. The login operation will be described below with reference to FIG. 12.

A screen 801 is a setting menu screen displayed in response to the setting area 235 being touched on the home screen displayed on the liquid crystal touchscreen 226 of the image processing apparatus 200. In response to “MAIN BODY SETTING” being touched on the screen 801, the screen transitions to a screen 802. In response to “GUEST USER SETTING” being touched on the screen 802, the screen transitions to a screen 803. In response to “ENABLE/DISABLE GUEST USER” being touched on the screen 803, the screen transitions to a screen 804. In response to “GUEST USER RESTRICTION” being touched, the screen 803 transitions to a screen 805. On the screen 804, the setting value of item ID 02001 “enable guest user” can be changed.

In response to “ENABLE” or “DISABLE” being touched on the screen 804, the screen transitions to a screen 806. The setting management application 254 receives a request for a change in the setting of item ID 02001 “ENABLE GUEST USER” via the apparatus UI control module 252. In a case where “enable” is touched on the screen 804, the setting management application 254 stores “ON” as the setting value of item ID 02001 into the NVRAM 215 via the setting value storage module 262. In a case where “DISABLE” is touched on the screen 804, the setting management application 254 stores “OFF” as the setting value of item ID 02001 into the NVRAM 215 via the setting value storage module 262. After completion of the storage of the setting value of item ID 02001, the setting management application 254 notifies the apparatus UI control module 252 of the completion of the setting change. The screen displayed on the liquid crystal touchscreen 226 transitions to a screen 807. In response to the OK button being touched on the screen 807, the screen returns to the screen 803.

On the screen 805, which is displayed in response to “GUEST USER RESTRICTION” being touched on the screen 803, the settings of the guest user restrictions represented by item IDs 02002 to 02005 can be changed. The screen 805 displays a plurality of checkboxes and an OK button. The guest user restrictions can be set by the user touching the checkboxes to switch the respective items between “ON” and “OFF” and touching the OK button. In response to the OK button being touched, the screen transitions to the screen 806. The apparatus UI control module 252 requests the setting management application 254 to change the settings of the guest user restrictions represented by item IDs 02002 to 02005.

In accordance with the request content, the setting management application 254 stores “ON” or “OFF” as the setting values of item IDs 02002 to 02005 into the NVRAM 215 via the setting value storage module 262. After completion of the storage of the setting values of item IDs 02002 to 02005, the setting management application 254 notifies the apparatus UI control module 252 of the completion of the setting change. The screen displayed on the liquid crystal touchscreen 226 transitions to the screen 807. In response to the OK button being touched on the screen 807, the screen returns to the screen 803.

FIG. 12 illustrates an example of a login screen displayed on the operation display unit 201 when the setting value of item ID 02001 “ENABLE GUEST USER” is “ON”. Prompting the user to perform a login operation allows the apparatus UI control module 252 to determine whether the user operating the operation display unit 201 is an administrator user or a guest user.

A screen 901 is a screen before login. In response to “GUEST USER” being touched in the screen 901, the screen transitions to a screen 902. In response to “ADMINISTRATOR USER” being touched, the screen transitions to a screen 903. In a case of transition to the screen 902, the apparatus UI control module 252 stores the information that the user is logged in as a guest user. The screen 902 is the home screen when the user is logged in as a guest user.

In a case where the logout button is touched on this screen 902 or a certain time (for example, one minute) elapses without any operation, the user is regarded to have logged out and the screen returns to the screen 901.

The screen 903 is a screen for authentication using an administrator password to log in as an administrator user. The screen 903 includes an input field for an administrator password. In response to the user touching on the input field, a software keyboard is displayed to prompt the user to input the administrator password. In response to the user inputting the administrator password and touching the OK button, the processing proceeds to determination 904.

In determination 904, the apparatus UI control module 252 acquires the input information and transmits a request for administrator password authentication to the setting management application 254. The setting management application 254 compares the information about the administrator password acquired by the user input and the administrator password value stored in the NVRAM 215, and determines whether the information and the administrator password value match. In a case where the two do not match, the setting management application 254 determines that the administrator password authentication is failed. In a case where the two match, the setting management application 254 determines that the administrator password authentication is successful. In a case where the administrator password authentication is failed, the screen transitions to a screen 905, and the user is notified of the failure of the administrator password authentication. In response to the OK button being touched on this screen 905, the screen 903 is displayed again to prompt the user to input the administrator password. In case where the administrator password authentication is successful, the screen transitions to a screen 906.

In a case of transition to the screen 906, the apparatus UI control module 252 stores the information that the user is logged in as an administrator user. The screen 906 is the home screen when the user is logged in as an administrator user. In a case where the logout button is touched on this screen 906 or a predetermined time (for example, one minute) elapses without any operation, the user is considered to have logged out and the screen returns to the screen 901.

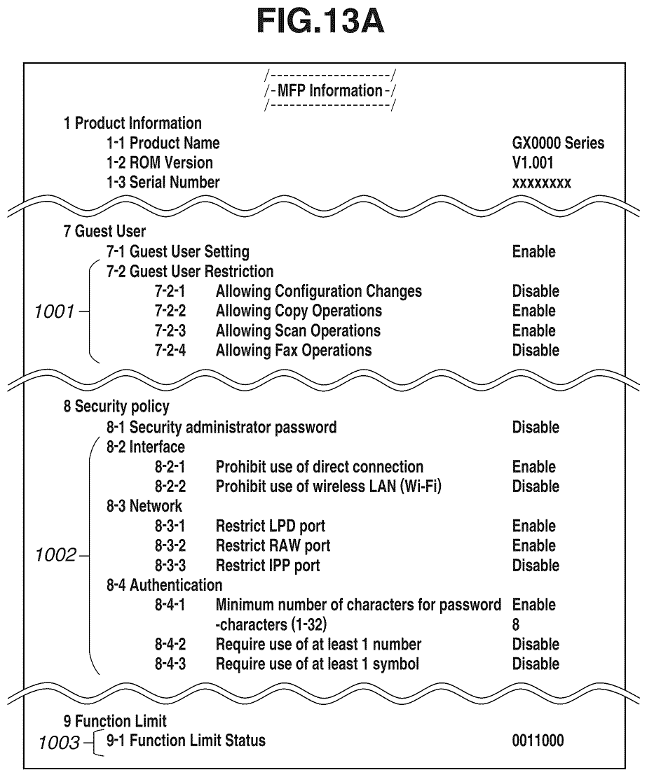

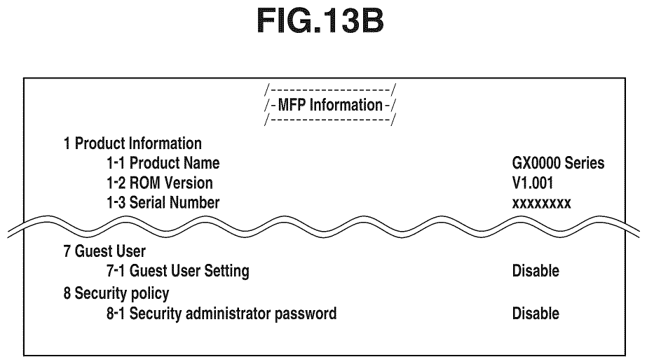

Next, an operation when information including the setting statuses of the security policy settings, the operation restriction settings, and the guest user restrictions is output by a device information print function of the image processing apparatus 200 will be described with reference to FIGS. 13A and 13B. FIGS. 13A and 13B illustrate examples of output in execution of the device information print function.

The device information print function of the image processing apparatus 200 is a function of outputting some of the setting statuses of the image processing apparatus 200 as a print product. The device information print function is executed when “PRINT DEVICE INFORMATION” is touched on the screen 802 illustrated in FIG. 11. In response to “PRINT DEVICE INFORMATION” being touched, the setting management application 254 receives a request for execution of the device information print function via the apparatus UI control module 252. The setting management application 254 received the request acquires various setting values stored in the NVRAM 215 via the setting value storage module 262. The setting management application 254 then formats the acquired information into print data and prints the print data using the print unit 216. When formatting the information into the print data, the setting management application 254 checks whether any restriction is enabled for each restriction function, based on the restriction tables 410 to 430 of the restriction functions illustrated in FIGS. 7A to 7C. As for a restriction function not having any enabled restriction, the restriction function is excluded from the output result.

FIG. 13A illustrates an output result when there are restrictions imposed by security policy settings, operation restriction settings, and guest user restrictions. An area 1001 lists the setting statuses of the guest user restrictions corresponding to item IDs 02002 to 02005 on an item basis.

An area 1002 lists the setting statuses of the security policy settings corresponding to item IDs 10001 to 10008 on an item basis. An area 1003 expresses the setting statuses of the operation restriction settings corresponding to item IDs 20001 to 20007 on an item basis in a bit string of 0s and 1s.

FIG. 13B illustrates an output result when no restriction is imposed by the security policy settings, the operation restriction settings, or the guest user restrictions. A comparison with the FIG. 13A shows that the items corresponding to the areas 1001 to 1003 are absent.

The exclusion of the disabled restriction functions from the output result of the device information printing can reduce the number of print sheets and the amount of ink for printing of the device information without impairing user convenience.

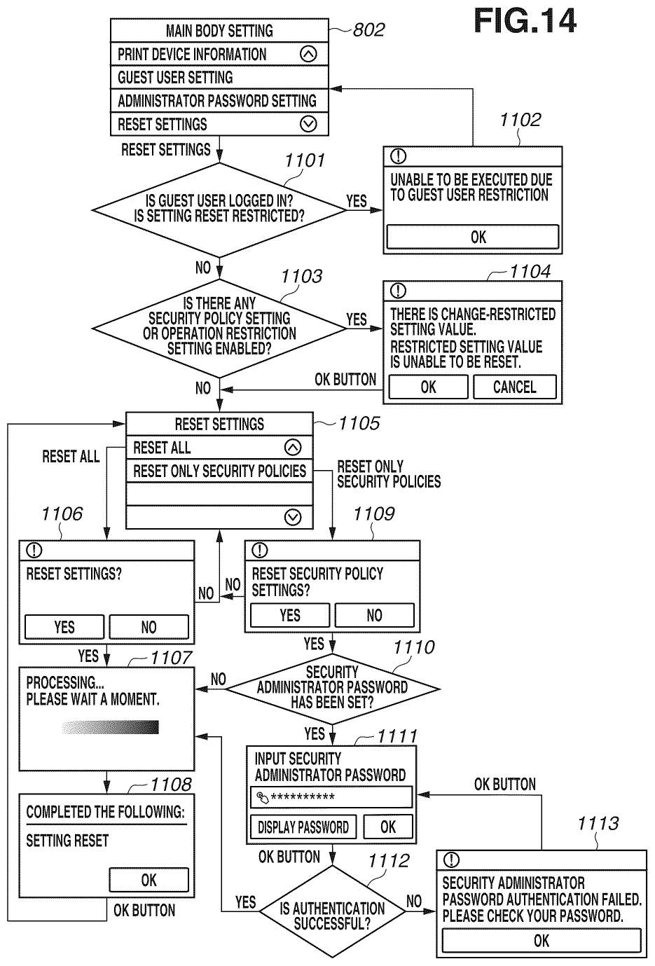

Now, the setting reset function for performing initialization processing on the settings of the image processing apparatus 200 will be described with reference to FIG. 14. FIG. 14 illustrates a screen flow in resetting various setting values stored in the NVRAM 215 through UI operations performed on the main body of the image processing apparatus 200.

In response to “RESET SETTINGS” being touched on the screen 802 described with reference to FIG. 11, the processing proceeds to determination 1101. In determination 1101, the apparatus UI control module 252 performs determination of whether a guest user is logged in and whether setting reset is restricted. Specifically, the apparatus UI control module 252 performs determination of whether the login user information indicates a guest user. The apparatus UI control module 252 then acquires the value of item ID 02002 “GUEST USER RESTRICTION: ALLOW SETTING CHANGES” from the NVRAM 215, and performs determination of whether the value is “OFF”. In a case where the login user information indicates a guest user and the value of item ID 02002 is “OFF”, the apparatus UI control module 252 determines that the setting reset is restricted. In a case where the setting reset is restricted, the screen transitions to a screen 1102. In a case where the setting reset is not restricted, the processing transitions to determination 1103.

The screen 1102 notifies the user that the setting reset is restricted by the guest user restriction. In response to the OK button being touched on this screen 1102, the screen returns to the screen 802.

In determination 1103, the apparatus UI control module 252 inquires of the setting management application 254 about whether any security policy or operation restriction setting is enabled. In a case where any security policy setting or operation restriction setting is enabled, the screen transitions to a screen 1104. In a case where there is no security policy setting or operation restriction setting enabled, the screen transitions to a screen 1105.

In this process, the setting management application 254 acquires the security policy settings and the operation restriction settings stored in the NVRAM 215 via the setting value storage module 262, and performs determination of whether any of the settings is enabled. Specifically, the setting management application 254 acquires the setting values of the security policy settings represented by item IDs 10001 to 10008 and the setting values of the operation restriction settings represented by item IDs 20001 to 20007 from the NVRAM 215. In a case where any of the acquired values is other than “0” or “OFF”, the setting management application 254 determines that there is a security policy setting enabled.

The screen 1104 notifies the user that the setting value restricted by the security policy setting or operation restriction setting may not be reset. In response to the OK button being touched on this screen 1104, the screen transitions to a screen 1105.

The screen 1105 lists menu items for the respective setting reset functions. In response to “RESET ALL” being touched here, the screen transitions to a screen 1106. In response to “RESET ONLY SECURITY POLICIES” being touched, the screen transitions to a screen 1109.

The screen 1106 is a screen on which the user determines whether to perform the full setting reset processing. In response to the “YES” button being touched, the screen transitions to a screen 1107. In response to the “NO” button being touched, the screen transitions to the screen 1105. In a case of transition from the screen 1106 to the screen 1107, the apparatus UI control module 252 transmits a request for the full setting reset processing to the setting reset application 255. The setting reset application 255 received the request for the full setting reset processing changes settings based on the initial values listed in the column 403 of the setting item management information 400 and the initialization request-specific reset flags listed in the column 404. In this processing, the setting reset application 255 does not reset the setting values of the security policy settings, the operation restriction settings, and the setting values restricted by the restriction tables 410 and 420 illustrated in FIGS. 7A and 7B. After completion of the full setting reset processing, the screen transitions to a screen 1108.

The screen 1109 is a screen on which the user determines whether to perform the security policy reset processing. In response to the “YES” button being touched, the processing proceeds to determination 1110. In response to the “NO” button being touched, the screen transitions to the screen 1105. In determination 1110, the apparatus UI control module 252 acquires the setting value of item ID 01001 “SECURITY ADMINISTRATOR PASSWORD SETTING” via the security policy setting application 253 and the setting value storage module 262. In a case where the acquired value is “NO”, the screen transitions to the screen 1107. In a case where the acquired value is “YES”, the screen transitions to a screen 1111.

The screen 1111 is a screen for authentication using a security administrator password. The screen 1111 includes an input field for a security administrator password. In response to the user touching the input field, a software keyboard is displayed to prompt the user to input a security administrator password. In response to the user inputting a security administrator password and touching the OK button, the processing proceeds to determination 1112.

In determination 1112, the apparatus UI control module 252 acquires the input information and transmits a request for the security administrator password authentication to the security policy setting application 253. The security policy setting application 253 compares the information about the security administrator password acquired by the user input and the security administrator password value stored in the NVRAM 215, and determines whether the information and the security administrator password value match. In a case where the two do not match, the security policy setting application 253 determines that the security administrator password authentication is failed. In a case where the two match, the security policy setting application 253 determines that the security administrator password authentication is successful. In a case where the security administrator password authentication is failed, the screen transitions to a screen 1113 to notify the user of the failure of the security administrator password authentication. In response to the OK button being touched on the screen 1113, the screen 1111 is displayed again to prompt the user to input a security administrator password. In a case where the security administrator password authentication is successful, the screen transitions to the screen 1107.

In the transition from the determination 1110 or 1112 to the screen 1107, the apparatus UI control module 252 transmits a request for the security policy reset processing to the setting reset application 255. In response to receipt of the request for the security policy reset processing, the setting reset application 255 changes settings based on the initial values listed in the column 403 of the setting item management information 400 and the initialization request-specific reset flags listed in the column 404. After completion of the security policy reset processing, the screen transitions to the screen 1108.

The screen 1108 is a screen indicating the completion of various types of reset processing. In response to the user touching the OK button on this screen 1108, the screen returns to the screen 1105.

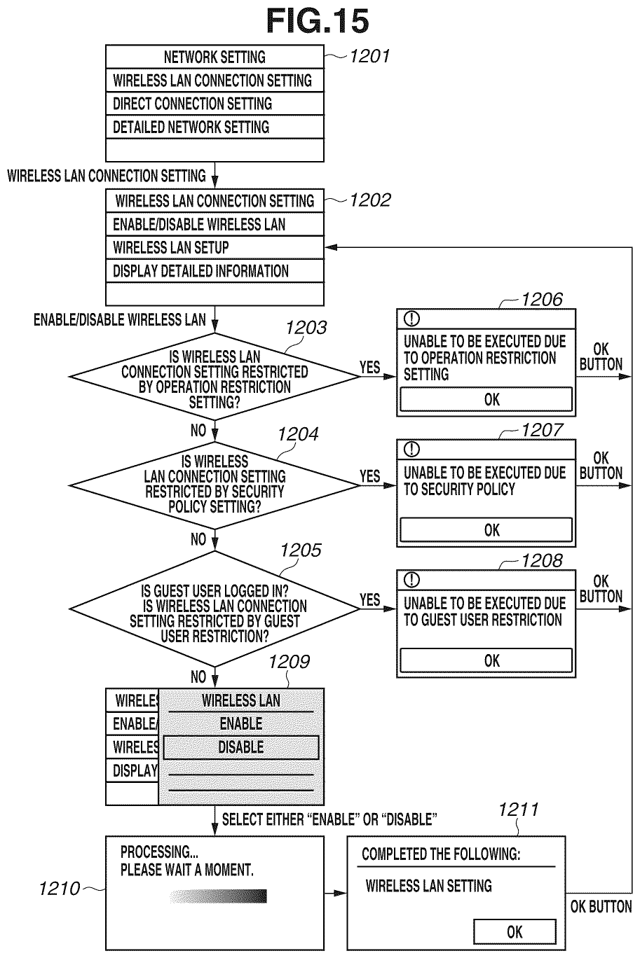

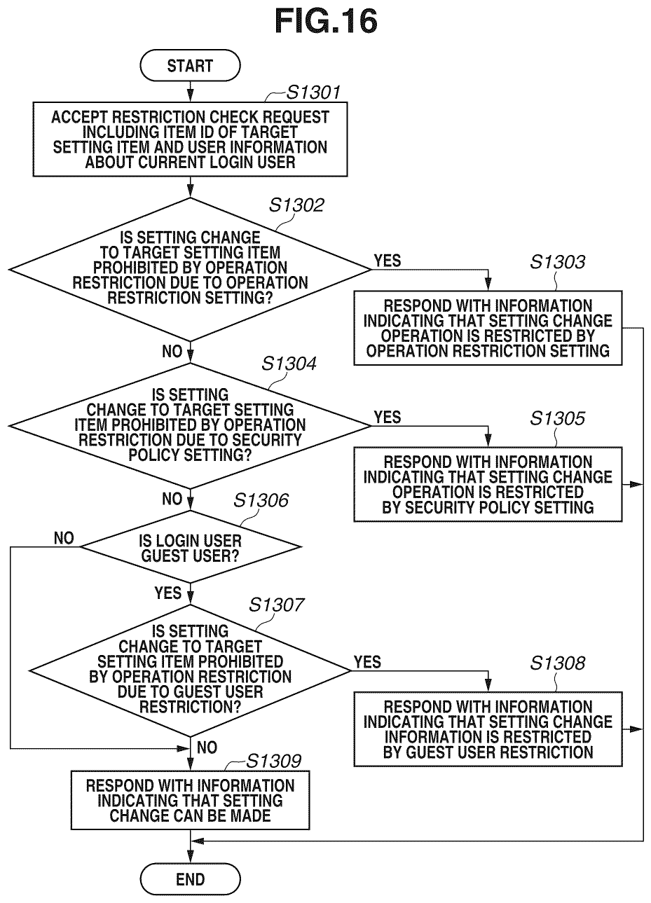

Next, referring to FIGS. 15 and 16, operation when setting changes are restricted by the restriction functions will be described by using the setting change operation of item ID 00004 “WIRELESS LAN CONNECTION SETTING” as an example.

FIG. 15 illustrates examples of setting screens in execution of the wireless LAN connection setting of the image processing apparatus 200. The screen flow illustrated in FIG. 15 is processed by the CPU 211 executing a program stored in the ROM 213. The apparatus UI control module 252 is mainly in charge of the control.

A screen 1201 is a network setting menu screen displayed in response to the network area 234 being touched on the home screen displayed on the liquid crystal touchscreen 226 of the image processing apparatus 200. In response to “WIRELESS LAN CONNECTION SETTING” being touched on this screen 1201, the screen transitions to a screen 1202.

In response to “ENABLE/DISABLE WIRELESS LAN” being touched on the screen 1202, the processing proceeds to processing in which determination of whether a change in the wireless LAN connection setting is restricted is performed, as illustrated in determinations 1203 to 1205. Specific determination processing is implemented by the apparatus UI control module 252 transmitting a restriction check request to the setting management application 254, which will be described below with reference to FIG. 16.

In determination 1203, the setting management application 254 initially performs determination of whether the wireless LAN control setting is restricted by the operation restriction setting. In a case where the wireless LAN control setting is restricted, the screen transitions to a screen 1206. In a case where the wireless LAN control setting is not restricted, the processing proceeds to determination 1204. The screen 1206 is a screen notifying the user that the current operation is restricted by the operation restricting setting. In response to the OK button being touched on this screen 1206, the screen returns to the screen 1202.

In determination 1204, the setting management application 254 performs determination of whether the wireless LAN connection setting is restricted by the security policy setting. In a case where the wireless LAN connection setting is restricted, the screen transitions to a screen 1207. In a case where the wireless LAN connection setting is not restricted, the processing proceeds to determination 1205. The screen 1207 is a screen notifying the user that the current operation is restricted by the security policy setting. In response to the OK button being touched on this screen 1207, the screen returns to the screen 1202.

In determination 1205, the setting management application 254 performs determination of whether the wireless LAN connection setting is restricted by the guest user restriction. In a case where the wireless LAN connection setting is restricted, the screen transitions to a screen 1208. In a case where the wireless LAN connection setting is not restricted, the screen transitions to a screen 1209. The screen 1208 is a screen notifying the user that the current operation is restricted by the guest user restriction. In response to the OK button being touched on this screen 1208, the screen returns to the screen 1202.

The screen 1209 displays wireless LAN connection setting options. In this screen example, in response to either of “ENABLE” and “DISABLE” being touched, the screen transitions to a screen 1210. The screen 1210 notifies the user that the setting change is in progress while the apparatus UI control module 252 executes the setting change of the image processing apparatus 200.

For example, in response to “ENABLE” being touched on the screen 1209, the apparatus UI control module 252 changes the setting value of item ID 00004 “WIRELESS LAN CONTROL SETTING” to “ON” via the setting management application 254 and the setting value storage module 262. For example, in response to “DISABLE” being touched on the screen 1209, the apparatus UI control module 252 similarly changes the setting value of item ID 00004 to “OFF”.

After completion of the setting change processing of the image processing apparatus 200, the screen transitions to a screen 1211 to notify the user of the completion of the setting change. In response to the OK button being touched on this screen 1211, the screen returns to the screen 1202.

While FIG. 15 illustrates the case where the setting change is performed through UI operations on the main body of the image processing apparatus 200, the setting change method is not limited thereto. For example, the setting change may be implemented using a web UI. Even in such a case, a setting change procedure and setting change restrictions similar to those of the screen flow described with reference to FIG. 15 can be exercised.

FIG. 16 is a flowchart illustrating processing when the setting management application 254 of the image processing apparatus 200 receives a restriction check request from the web UI control module 251 or the apparatus UI control module 252.

In step S1301, the setting management application 254 accepts a restriction check request including the item ID of the target setting item of the setting change operation and user information about the current login user. In step S1302, the setting management application 254 performs determination of whether a setting change to the received target setting item of the setting change is prohibited by an operation restriction due to an operation restriction setting.

Specifically, the setting management application 254 acquires the setting values of the operation restriction settings represented by item IDs 20001 to 20007 from the NVRAM 215. The setting management application 254 extracts enabled operation restriction settings based on the restriction table 420 of the operation restriction settings illustrated in FIG. 7B. The setting management application 254 checks the column 423 for the extracted enabled operation restriction settings, and determines whether the item ID of the target setting item of the setting change is subject to any operation restriction, i.e., the setting change is prohibited. In a case where the setting change is prohibited (YES in step S1302), the processing proceeds to step S1303. In a case where the setting change is not prohibited (NO in step S1302), the processing proceeds to step S1304.

In step S1303, the setting management application 254 responds to the restriction check request with information indicating that the setting change operation is restricted by the operation restriction setting, and performs screen display like the screen 1206.

In step S1304, the setting management application 254 checks whether the setting change to the received target setting item of the setting change is prohibited by an operation restriction due to a security policy setting.

Specifically, the setting management application 254 acquires the setting values of the security policy settings represented by item IDs 10001 to 10008 from the NVRAM 215. The setting management application 254 then extracts enabled security policy settings based on the restriction table 410 of the security policy settings illustrated in FIG. 7A. The setting management application 254 checks the column 413 for the extracted enabled security policy settings, and performs determination of whether the item ID of the target setting item of the setting change is subject to any operation restriction, i.e., the setting change is prohibited. In a case where the setting change is prohibited (YES in step S1304), the processing proceeds to step S1305. In a case where the setting change is not prohibited (NO in step S1304), the processing proceeds to step S1306.

In step S1305, the setting management application 254 responds to the restriction check request with information indicating that the setting change operation is restricted by the security policy setting, and performs screen display like the screen 1207.

In step S1306, the setting management application 254 performs determination of whether the login user is a guest user, based on the received user information about the current login user. In a case where the login user is a guest user (YES in step S1306), the processing proceeds to step S1307. In a case where the login user is not a guest user (NO in step S1306), the processing proceeds to step S1309.

In step S1307, the setting management application 254 performs determination of whether the setting change to the received target setting item of the setting change is prohibited by an operation restriction due to a guest user restriction.

Specifically, the setting management application 254 acquires the setting values of the guest user restrictions represented by item IDs 02002 to 02005 from the NVRAM 215. The setting management application 254 extracts enabled guest user restrictions, based on the restriction table 430 of the guest user restrictions illustrated in FIG. 7C. The setting management application 254 checks the column 433 for the extracted enabled guest user restrictions, and performs determination of whether the item ID of the target setting item of the setting change is subject to any operation restriction, i.e., the setting change is prohibited. In a case where the setting change is prohibited (YES in step S1307), the processing proceeds to step S1308. In a case where the setting change is not prohibited (NO in step S1307), the processing proceeds to step S1309.

In step S1308, the setting management application 254 responds to the restriction check request with information indicating that the setting change operation is restricted by the guest user restriction, and performs screen display like the screen 1208. In step S1309, the setting management application 254 responds to the restriction check request with information indicating that the setting change can be performed to the target setting item of the setting change. The processing ends.

By controlling the image processing apparatus 200 as described above, even in a case where a plurality of function restrictions with different use purposes, such as security policy settings, operation restriction settings, and guest user restrictions, are set, the operation of the image processing apparatus 200 can be restricted while factoring in each of the restrictions.

As illustrated on the screens 1206 to 1208 of FIG. 15, different notification screens can be displayed for respective restrictions. In other words, the user operating the image processing apparatus 200 can be informed by a notification screen indicating which restriction function restricts the operation, and can request the administrator user or the security administrator user to lift the restriction as appropriate.

In the first exemplary embodiment, in the determination of whether a setting change operation is restricted, the restriction functions are checked in a fixed order. This method involves reordering the processing sequences if the checking order is changed. In view of this, a second exemplary embodiment introduces the concept of priority into the restriction functions, and discloses a method for checking the presence or absence of restriction in descending order of priority. Consequently, the checking order of the restriction functions can be changed simply by changing their priorities.

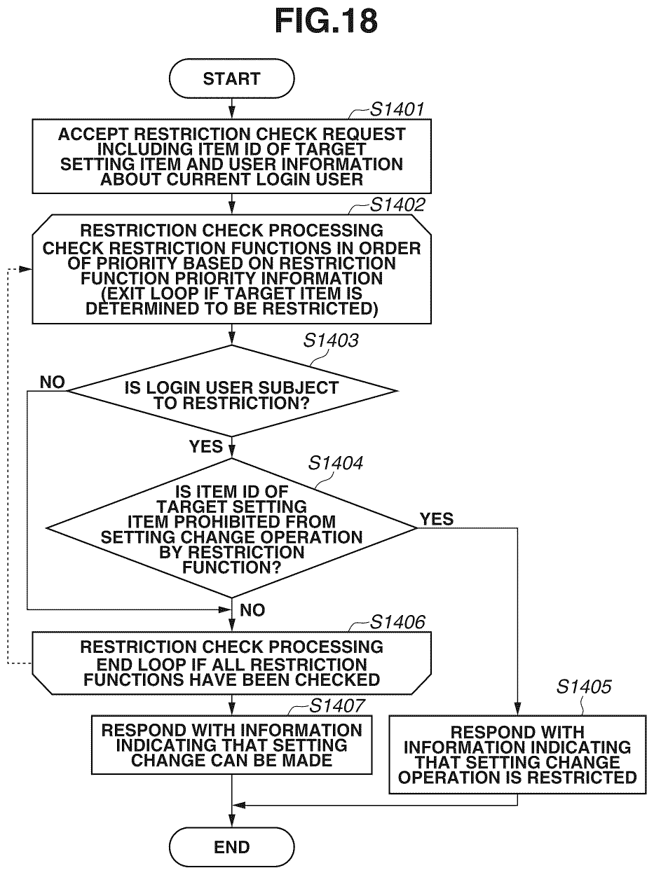

The description given with reference to FIGS. 1 to 15 is common to the first exemplary embodiment and the present exemplary embodiment, and the redundant description will be omitted. Note that the specific processing of determinations 1203 to 1205 in FIG. 15 is replaced with that of the flowchart to be described with reference to FIG. 18.

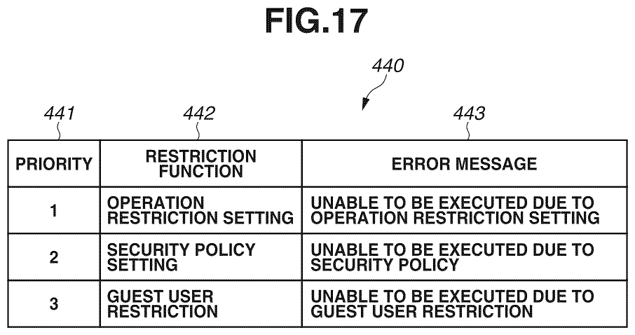

FIG. 17 is a diagram schematically illustrating information indicating the priorities of the restriction functions of the image processing apparatus 200 as restriction function priority information 440. A column 441 includes a plurality of rows, which are assigned numerical values indicating priorities. The smaller the numerical value, the higher the priority. A column 442 lists restriction function names, whereby the priorities are linked with the respective restriction functions. A column 443 lists error messages to be displayed on a screen in a case where the operation is restricted by the respective restriction functions.

While FIG. 17 illustrates the restriction function priority information 440 in a table form, the format in which the image processing apparatus 200 stores such information is not limited to a table form. For example, the information may be stored in a specific database format, stored in a JSON file format, or expressed as a program stored in the ROM 213.

FIG. 18 is a flowchart illustrating processing when the setting management application 254 of the image processing apparatus 200 according to the present exemplary embodiment receives a restriction check request from the web UI control module 251 or the apparatus UI control module 252.

In step S1401, the setting management application 254 accepts a restriction check request including the item ID of the target setting item of the setting change operation and the user information about the current login user.

The setting management application 254 then performs loop processing illustrated in steps S1402 to S1406. In this loop processing, determination of whether the target setting item of the setting change operation is restricted is performed in descending order of priority of the restriction functions, based on the restriction function priority information 440. Specifically, in the example illustrated in FIG. 17, the operation restriction settings are initially processed, followed by the security policy settings and finally the guest user restrictions.

In the loop processing, in step S1403, the setting management application 254 initially determines whether the login user is subject to the restriction function.

Specifically, the setting management application 254 checks the restriction tables 410 to 430 illustrated in FIGS. 7A to 7C for operation restriction information corresponding to the restriction function, and performs determination of whether the login user in the user information received as the restriction check request is subject to restriction. For example, in a case where this processing is for an operation restriction setting, the setting management application 254 checks the column 423 of the restriction table 420 of the operation restriction settings. Since the column 423 shows that the restrictions are targeted for all users, the login user is subject to restriction regardless of whether the login user is an administrator user or a guest user. For example, in a case where this processing is for a guest user restriction, the setting management application 254 checks the column 433 of the restriction table 430 of the guest user restrictions. Since the column 433 shows that the restrictions are targeted only for guest users, the login user is not subject to restriction in a case where the login user is an administrator user, and is subject to restriction in a case where the login user is a guest user. In a case where the login user is subject to the restriction function (YES in step S1403), the processing proceeds to step S1404. In a case where the login user is not subject to the restriction function (NO in step S1403), the processing proceeds to step S1406.

In step S1404, the setting management application 254 performs determination of whether the item ID of the target setting item of the setting change operation is prohibited from the setting change operation by the restriction function.

Specifically, the setting management application 254 acquires an item ID list corresponding to the setting of the restriction function from the restriction tables 410 to 430 illustrated in FIGS. 7A to 7C, and acquires the setting values on the item ID list from the NVRAM 215 via the setting value storage module 262. The setting management application 254 extracts a row or rows where restriction is triggered based on the setting values acquired from the restriction tables. The setting management application 254 checks the extracted row(s) to see whether the item ID of the target setting item of the setting change operation is included as the target of the operation restriction. In a case where the item ID is included as the target of the operation restriction, the setting management application 254 determines that the setting change operation is prohibited. For example, in a case where the processing is for an operation restriction setting, the setting management application 254 checks the column 421 of the restriction table 420 of the operation restriction settings. Since the operation restriction settings correspond to item IDs 20001 to 20007, the setting management application 254 acquires their setting values from the NVRAM 215. The setting management application 254 performs determination of whether the acquired setting values match the respective values to trigger restriction. A row where the values match means that the restriction is enabled. The setting management application 254 checks the column 423 for rows where the restriction is enabled, and performs determination of whether the item ID of the target setting item of the setting change operation is included as the target of the operation restriction. In a case where the setting change operation is prohibited (YES in step S1404), the processing proceeds to step S1405. In a case where the setting change operation is not prohibited (NO in step S1404), the processing proceeds to step S1406.

In step S1405, the setting management application 254 exits the loop processing, and responds to the restriction check request with information indicating that the setting change operation is restricted. The processing ends.

Specifically, the setting management application 254 acquires the error message corresponding to the restriction function from the column 443 of the restriction function priority information 440, and returns a value indicating restriction and the error message as a response to the restriction check request. For example, in a case where this processing is for an operation restriction setting, the setting management application 254 acquires the message “UNABLE TO BE EXECUTED DUE TO OPERATION RESTRICTION SETTING” from the column 443 of the restriction function priority information 440, and returns the error message along with a return value indicating restriction. The web UI control module 251 or the apparatus UI control module 252 receiving the response displays a screen indicating that the operation is unable to be executed, including the error message, whereby the user is notified that the operation is restricted.

In a case where it is determined that the operation is not be restricted in step S1403 or S1404, the processing proceeds to step S1406 and returns to step S1402 to process the restriction function of the next highest priority based on the restriction function priority information 440. In a case where all the restriction functions have been checked, the loop ends and the processing proceeds to step S1407.

In step S1407, the setting management application 254 determines that the operation is not restricted, and responds to the restriction check request with a value indicating that the setting change can be performed.

The foregoing description has shown that the checking order of the restriction functions can be changed based on priority without reordering the individual operation sequences. The priorities in the restriction function priority information 440 may be changeable, in which case the restriction function priority information 440 can be stored in the NVRAM 215 so that the priorities can be changed from the web UI or apparatus UI of image processing apparatus, or the maintenance tool.

While the security policy settings, operation restriction settings, and guest user restrictions have been described as examples of the restriction functions, these are not restrictive. For example, in addition to administrator users and guest users, there may be users of general attribute (called general users), and general user restriction functions that associate the user IDs of general users with operation restrictions may be implemented.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to an exemplary embodiment of the present disclosure, a mechanism can be provided to, when a plurality of function restrictions with different use purposes is enabled on an image processing apparatus, appropriately restrict the operation of the image processing apparatus while factoring in each of the restrictions.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-119684, which was filed on Jul. 24, 2023 and which is hereby incorporated by reference herein in its entirety.

What is claimed is:

1. An image processing apparatus comprising:
one or more memories storing instructions; and
one or more processors capable of executing the instructions, wherein execution of the instructions causes the one or more processors to cause the image processing apparatus to:
enable restriction on some functions of the image processing apparatus as a first function restriction,
enable restriction on some functions of the image processing apparatus as a second function restriction different from the first function restriction, and
perform control on a function targeted for restriction by both the first function restriction and the second function restriction, in accordance with a setting value of the function based on the restrictions.

2. The image processing apparatus according to claim 1,
wherein the first function restriction is set by the image processing apparatus using a dedicated tool, and
wherein the instructions further cause the image processing apparatus to present, in a case where use of a function targeted for restriction by the first function restriction and second function restriction is instructed, a screen indicating that use of the function is restricted by the first function restriction, not by the second function restriction.

3. The image processing apparatus according to claim 2, wherein in a case where use of a function not targeted for restriction by the first function restriction but targeted for restriction by the second function restriction is instructed, a screen indicating that use of the function is restricted by the second function restriction is presented.

4. The image processing apparatus according to claim 1, wherein the second function restriction is a restriction that is set as a security policy by a security administrator in a case where the security administrator has been successfully authenticated.

5. The image processing apparatus according to claim 1,
wherein the instructions further cause the image processing apparatus to perform initialization processing for initialing a setting of the image processing apparatus, and
wherein first initialization processing or second initialization processing is performed as the initialization processing, the first initialization processing being not to initialize a setting intended for the first function restriction and the second function restriction, the second initialization processing being to initialize a setting intended for the second function restriction.

6. The image processing apparatus according to claim 1, wherein with respect to the function targeted for restriction by the first function restriction and the second function restriction, the control is performed in such a manner that the function is to be used with a setting value satisfying both the restrictions on respective targeted setting items.

7. A control method of an image processing apparatus comprising:
enabling restriction on some functions of the image processing apparatus as a first function restriction;
enabling restriction on some functions of the image processing apparatus as a second function restriction different from the first function restriction; and
performing control on a function targeted for restriction by both the first function restriction and the second function restriction, in accordance with a setting value of the function based on the restrictions.
